(19) United States
(12) Patent Application Publication
(10) Pub. No.: US 2016/0320312 A1
(43) Pub. Date: Nov. 3, 2016

(54) GEMSTONE IMAGING APPARATUS

(71) Applicant: TweezDiam, Ramat Gan (IL)

(72) Inventors: Michael KOLOMENKIN, Tel Aviv (IL); Yaron Cohen, Tel Aviv (IL); Carlo Rubinstein, Ramat Gan (IL)

(21) Appl. No.: 14/700,169

(22) Filed: Apr. 30, 2015

(51) Int. Cl. G01N 21/87; G01N 21/88

(52) U.S. Cl. CPC G01N 21/87; G01N 21/8806

(57) ABSTRACT

An imaging apparatus for imaging a gemstone having a plurality of planes is provided. The apparatus includes a gemstone holding area defining an optical aperture; a camera configured for capturing an image of at least one plane of the gemstone and being so disposed with respect to the area so as to allow capturing the image through the optical aperture from at least a first direction of the a gemstone holding area; an illumination device; and a sleeve member disposed about the optical aperture and being configured for directing illumination from the sleeve member towards the optical aperture such that at least the majority of the illumination enters the optical aperture at an angle in a range of 15 to 55 degrees with respect to the first direction.

### FIELD OF INVENTION

The presently disclosed subject matter relates to a gemstone imaging apparatus, in general, and in particular to a handheld gemstone imaging apparatus.

### BACKGROUND

Gemstone imaging apparatus are known and are vastly utilized by gemstone dealers, such as diamonds sellers etc., so as to allow remote selling of diamonds. A known gemstone imaging apparatus is provided by Sarine Loupe Imaging which is configured for scanning 360-degrees of a diamond or gemstone, The Sarine Loupe creates a video of a diamond rotating in front of the camera.

U.S. Pat. No. 7,336,347 discloses a methods for grading gemstones, apparatus for grading gemstones, and apparatus that utilize such methods and apparatus, specifically methods which trace rays through a computer representation of a gemstone wherein the rays enter the gemstone though the gemstone crown and allow a grade to be assigned to the gemstone represented based on the ray paths through the representation.

### SUMMARY OF INVENTION

There is provided according to an aspect of the presently disclosed subject matter an imaging apparatus for imaging a gemstone having a plurality of planes. The apparatus includes a gemstone holding area defining an optical aperture; a camera configured for capturing an image of at least one plane of the gemstone and being so disposed with respect to the area so as to allow capturing the image through the optical aperture from at least a first direction of the a gemstone holding area; an illumination device; and a sleeve member disposed about the optical aperture and being configured for directing illumination from the sleeve member towards the optical aperture such that at least the majority of the illumination enters the optical aperture at an angle in a range of 15 to 55 degrees with respect to the first direction.

The sleeve member can be configured to block at least a portion of the illumination directed towards the optical aperture at an angle in outside the range.

The gemstone holding area can include a gemstone holding member including a plate disposed therein and configured such that an image of the gemstone held on the plate can he obtained therethrough from a direction of a predetermined facet of the gemstone.

The plate can include an aperture configured to allow capturing the image therethrough.

The camera can include a plurality of cameras each being so disposed with respect to the optical aperture such that a plurality of images of the gemstone can be obtained each image being a captured from a predetermined direction. The camera can include a plurality of cameras each being configured to obtain an image of the gemstone in a predetermined light spectrum. The camera can be configured to obtain an image of the gemstone having at least one plane in focus.

The imaging apparatus can further include a focusing device configured to obtaining an in focus image of a predefined plane of the gemstone. The imaging apparatus can further include a diffusing member configured to evenly diffuse the illumination from the illumination device. The diffusing member can be mounted on a plate inside the housing and being so disposed with respect to the sleeve member such that illumination from the illumination device can be directed towards the diffusing member and such that diffused illumination from the diffusing member can be reflected towards the sleeve. The diffusing member can be configured for a negligible specular reflection of the illumination towards an inner surface of the sleeve member. The illumination device can include a plurality of illuminating elements each being disposed on one side of the gemstone holding area and being directed towards the diffusing member such that the diffusing member can be illuminated from multiple direction.

The sleeve member can include a symmetric shape, such illumination reflected therefrom can be symmetrically directed towards the optical aperture. The sleeve member can be slanted in a direction between the optical aperture and the camera. The sleeve member can be coaxially disposed with respect to the gemstone holding area such that the distance between the optical aperture and a surface of the sleeve member which reflects the illumination can be even from all directions. The sleeve member can be configured to reflect illumination towards the optical aperture such that the illumination impinges on inner facets of the gemstone forming thereby contrasts between the reflection of one inner facet and an adjacent inner facet.

The imaging apparatus can further include a light blocking member disposed about the gemstone holding area and being configured for blocking illumination directed to other facets of the gemstone other than the facets thereof from which it can be desired to obtain the image. The light blocking member can be integrally formed with the sleeve member.

The gemstone holding area can include an aperture for accessing the gemstone holding area from an outer surface of the apparatus, and a cap member configured to be disposed over the aperture and being configured to block light. The cap member further include a centralizing member configured to urge the gemstone in the gemstone holding area to be coaxially disposed with the camera.

There is provided in accordance with another aspect of the presently disclosed subject matter a method for capturing an image of a gemstone having a plurality of planes. The method includes placing a gemstone in gemstone holding area defining an optical aperture; disposing a camera with respect to the gemstone holding area such that an image of the gemstone can be captured through the optical aperture from at least a first direction of the a gemstone holding area; and illuminating the optical aperture such that at least the majority of the illumination enters the optical aperture at an angle in a range of 15 to 55 degrees with respect to the first direction; and capturing an image of at least one plane of the gemstone.

### BRIEF DESCRIPTION OF THE DRAWINGS

In order to understand the disclosure and to see how it may be carried out in practice, embodiments will now be described, by way of non-limiting examples only, with reference to the accompanying drawings, in which:

FIG. 1 is a perspective view of a gemstone imaging apparatus in accordance with an example of the presently disclosed subject matter;

FIG. 2A is a perspective view of the gemstone imaging apparatus of FIG. 1 with the cover portion thereof removed;

FIG. 2B is a perspective view of the base portion of the gemstone imaging apparatus of FIG. 1;

FIG. 3 is an exploded view of the gemstone imaging apparatus of FIG. 1;

FIG. 4 is a side sectional view of the gemstone imaging apparatus of FIG. 1 taken along lines A-A;

### DETAILED DESCRIPTION OF EMBODIMENTS

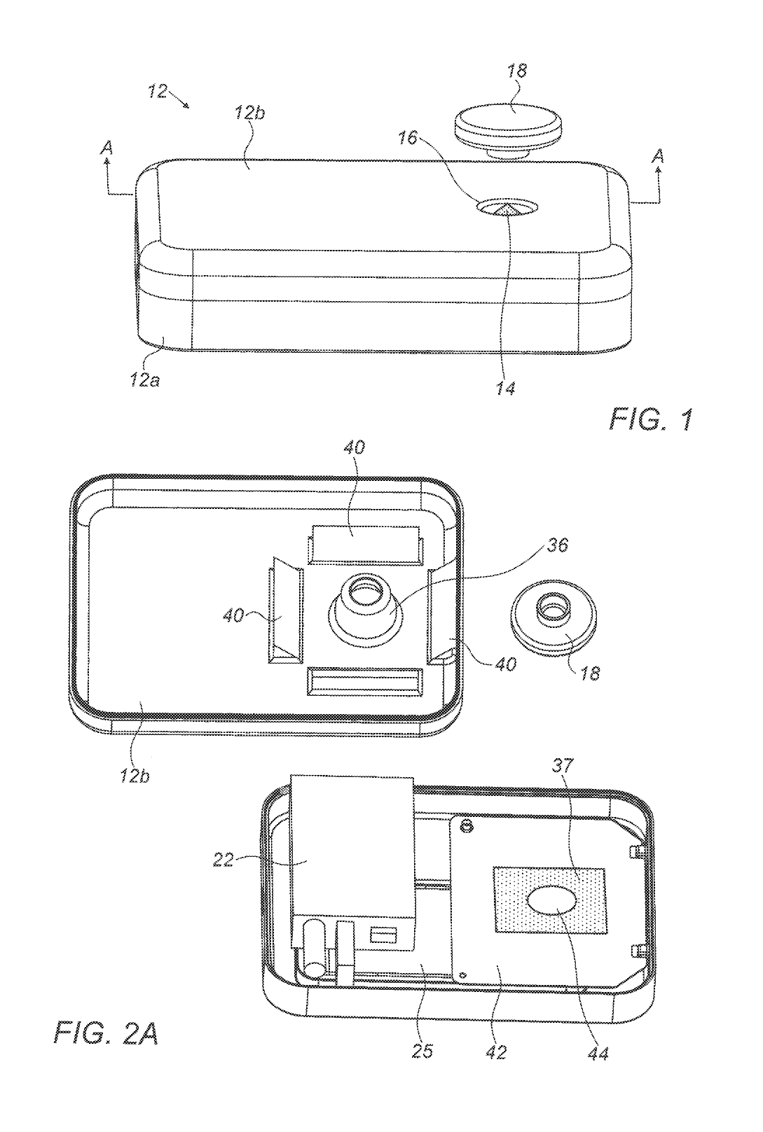

FIG. 1 shows a gemstone imaging apparatus 10 for imaging a gemstone 5, such as a diamond. The apparatus includes a housing 12 which can have for example a base portion 12a and a cover portion 12b, and can further include a gemstone holding area 14, an aperture 16 for accessing the gemstone holding area 14, and can further include a cap member 18 for covering the aperture.

According to the illustrated example, the gemstone holding area 14 is defined as a cylindrical member coupled to the cover portion 12a of the housing 12 adjacent to the aperture 16. The gemstone holding area 14 includes an optical aperture 15 through which the image is obtained. According to the illustrated example the optical aperture 15 is defined by an opening of cylindrical member.

The gemstone holding area 14 further includes a gemstone holding member 28, here illustrated as a transparent or translucent plate disposed at the gemstone holding area 14 and configured such that an image of the gemstone 5 held thereby can be obtained therethrough. Alternatively, the gemstone holding member 28, can be a stand, such as a ring stand, configured to hold the sides of the gemstone 5 such age can be obtained therethrough.

The gemstone holding member 28 according to the illustrated example is configured to hold the gemstone 5 such that the image is obtained from a direction of a predetermined facet thereof for example in a case of a diamond from the direction of the table thereof.

The base portion of the housing 12a holds therein a camera 30 and an optical apparatus 20 for obtaining an image of the gemstone 5, a power source 22 and a controller for actuating the camera 30. The controller can further include a transducer configured for wirelessly transmitting the obtained image to a remote location.

According to the illustrated example, the controller, the transducer and the camera 30 are provided in a handheld device 25 having a camera, such as an iPhone etc., disposed inside the housing 12. The transducer can thus be one which is embedded inside the handheld device 25, for example a Bluetooth transmitter, cellular transmitter, Wi Fi transmitter etc.

The camera 30 according to other example can be a standalone device, i.e. one which is not embedded in a handheld device. The camera can include more than one cameras each being so disposed with respect to the gemstone holding area 14 such that various images of the gemstone can be obtained each from one side thereof The camera can be configured to obtain a still frame image or a video footage of the gemstone.

In addition, the apparatus can include various cameras each being configured to obtain an image of the gemstone in a predetermined light spectrum, such as one camera can obtain an IR image of the gemstone while another camera is configured to obtain an image in the visible spectrum.

This way, the imaging apparatus 10 can be manufactured with the base portion 12a of the housing 12 having a seat 24 for a holding portable device and an optical apparatus 20, The user can dispose his handheld device 25 inside the seat 24 and activate the imaging apparatus 10 to obtain an image of the gemstone.

Alternatively, the apparatus can be configured such that a portable device is disposed on an outside surface thereof, for example a seat form on a top portion. According to this example, the housing of the apparatus contains an optical apparatus and a gemstone holding area while the portable device is disposed over an aperture through which the image of the gemstone can be obtained.

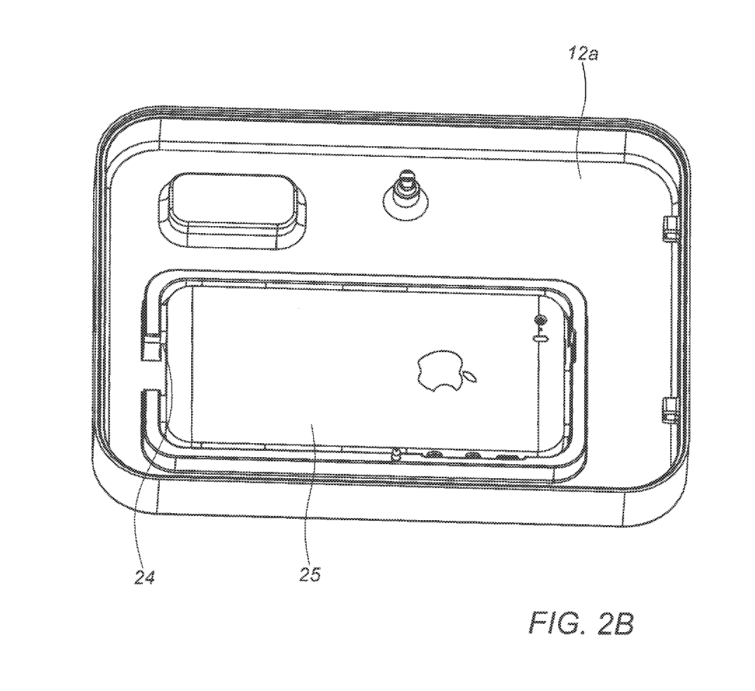

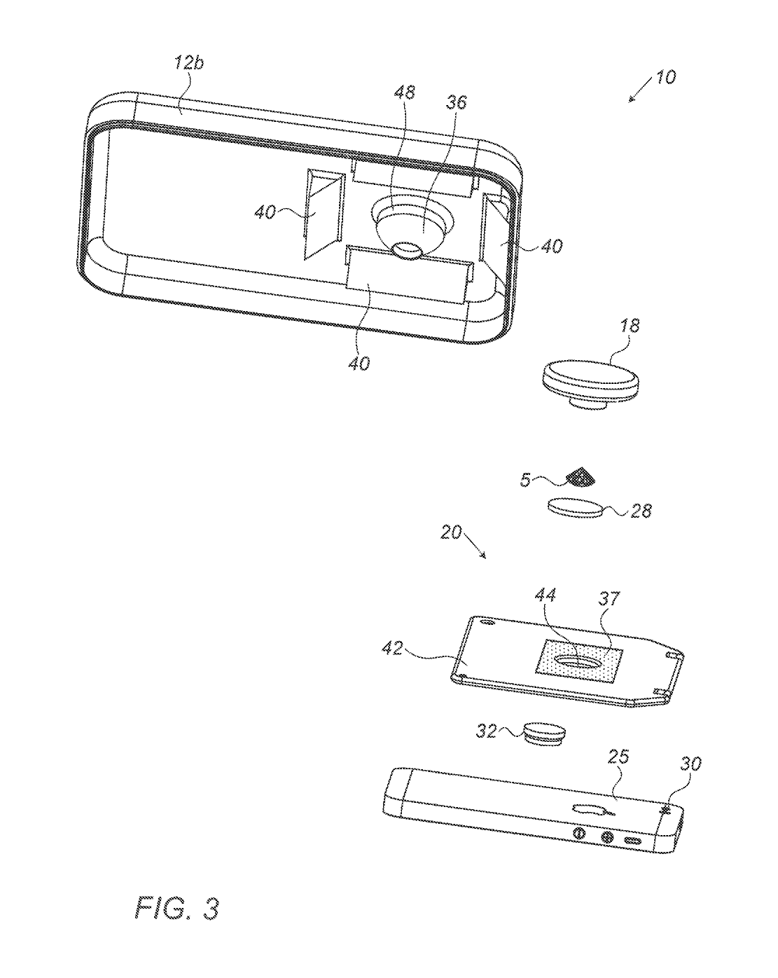

As shown in FIG. 2 the optical apparatus 20 includes a camera 30, which can be embedded in a handheld device 25, is configured for capturing an image of at least one plane of the gemstone 5. That is to say, the camera can be configured to obtain an image of the gemstone which includes at least one plane in focus. The camera 30 can thus be provided with a lens 32 or other focusing device, configured to allow obtaining an in focus image of a predefined plane of the gemstone 5. It is appreciated that the lens allows adapting the focus length as well as the depth of focus of the optical apparatus, such that the obtained image displays clear and sharp features at the desired plane of the gemstone 5.

The camera 30 is so disposed with respect to the gemstone holding area 14 so as to allow capturing the image from at least a first direction of the area, as explained hereinafter.

The optical apparatus 20 further includes an illumination device 40 configured to provide illumination corresponding to the properties of the camera 30. That is to say, the illumination provided by the illumination device 40 includes wavelength which can be detected by the camera 30. For example, in case the camera is configured to detect IR illumination, the illumination device 40 is configured to illuminate light at least in the IR spectrum.

It is appreciated that the illumination device 40 can be configured with more than one illumination, such as illuminations in various wavelength, etc. The camera 30 can thus be configured to obtain images with various illumination properties. Alternatively, the apparatus 10 can include two or more illumination devices each being configured to provide illumination having predefined properties. Similarly, the camera 30 can include more than one camera, each being configured to obtain an image with a predefined properties such as wavelength, power, etc. In addition, the apparatus can include a plurality of cameras 30 each being configured to obtain an image of the gemstone from a different direction thereof.

The optical apparatus 20 can further includes a diffusing member 37 configured to evenly diffuse the illumination from the illumination device 40. For example, if the illumination device 40 is a point light source, the diffusing member 37 can be configured to evenly diffuse the illumination.

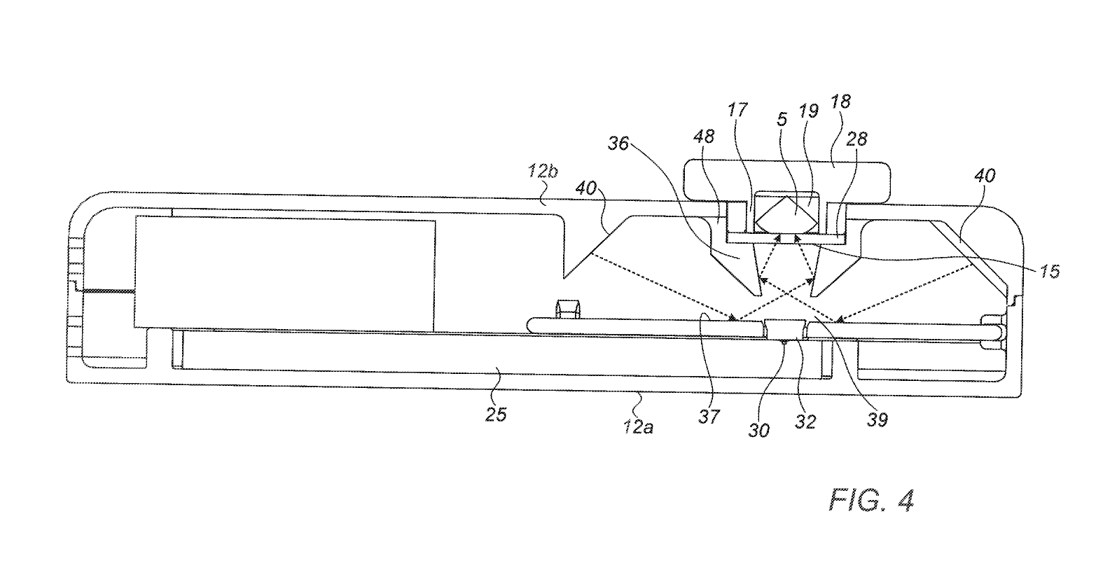

According to an example the diffusing member 37 is mounted on a plate 42 inside the housing disposed below the gemstone holding area 14. As Shown in FIG. 4, the illumination device 40 is configured to direct light downwardly towards the diffusing member 37 such that diffused illumination is reflected therefrom towards the sleeve member 36.

According to an example the diffusing member 37 can be configured for a negligible specular reflection of the illumination. This way, the majority of the illumination is diffused illumination, for example 95% of the illumination.

The optical apparatus 20 further includes a sleeve member 36 disposed about the optical aperture 16 of the gemstone holding area 14, and being configured for directing illumination from the diffusing member 37 towards the optical aperture 16.

That is to say the sleeve member 36 is disposed above the plate 42 on which the diffusing member 37 is mounted and is configured to receive illumination therefrom. The sleeve member 36 is configured such that at least the majority of the illumination from the illumination device 40 enters the optical aperture 16 at an angle in a range of 15 to 55 degrees with respect to the direction from which the image is captured. The sleeve member 36 can be further configured to block at least a portion of the illumination directed towards the optical aperture at an angle in outside the range of 15 to 55 degrees with respect to the direction from which the image is captured.

It is further appreciated that the sleeve member 36 includes a symmetric shape, such the light emitted from the diffusing member 37 symmetrically travels towards the optical aperture 15 of the gemstone holding area 14. In order to direct light towards the optical aperture 16 at an angle in a range of 15 to 55 degrees the sleeve is slightly slanted in a direction between the optical aperture 15 and the camera 30. It is appreciated that the slanting angle can vary depending on the gemstone held inside the gemstone holding area 14, and the disposition of the illumination device 40 with respect to the sleeve member 36. The illumination device 40 according to the illustrated example is mounted on an inner surface of the cover portion 12b of the housing 12 and includes a plurality of illuminating elements, such as four strips of LEDs etc., each being disposed on one side of the gemstone holding area 14 directed towards the diffusing member 37. Accordingly, the diffusing member 37 is illuminated from multiple directions, and the light is evenly reflected therefrom towards the sleeve member 36.

It is further appreciated that in order to provide the gemstone holding area 14 with an evenly and symmetrically distributed light, the sleeve member 36 is coaxially disposed with respect to the gemstone holding area 14 such that the distance between the optical aperture 15 of the gemstone holding area 14 and the reflecting surface of the sleeve member 36 is even from all directions.

This way, the gemstone receives illumination at an angle similar to the illumination received when an observer is viewing the gemstone, i.e. the direct illumination in 0-15 degrees is blocked by the observer's head. When the illumination is received mostly in the above range, i.e. at a range of 15 to 55 degrees with respect to the direction from which the image is captured, the inner facets of the gemstone reflect the light in such a way which provides contrasts between the reflection of one inner facet and an adjacent inner facet. The plate 42 can include an aperture 44 configured to hold the lens 32 therein, such that the camera 30, for example the handled device camera 30 is disposed underneath the lens 32. This way, the handheld device can be disposed in the seat 24 such that the optical apparatus 20 is adapted to allow capturing an image of a plane of the gemstone. Thus, the user does not have to adapt the optical apparatus 20 rather he can simply dispose the handheld device 25 inside the seat 24. The diffusing member 37 can thus be formed about the aperture 44.

The optical apparatus 20 can further include a light blocking member 48 for blocking illumination directed to other facets of the gemstone other than the facets thereof from which it is desired to obtain the image. That is to say, the light blocking member 48 is disposed such that the gemstone 5 is illuminated only from one side thereof, such that the image is captured with the gemstone being illuminated only from one side thereof. Thus, the light rays propagation inside the gemstone 5 is determined by the light impinging thereon from the one side thereof The image is thus Obtained by the camera 30 which captures reflection of light rays symmetrically impinging on the gemstone from a predetermined direction. The light blocking member 48 is thus configured to preclude interference of light rays from other directions. It is appreciated that the selected side of the gemstone from which it is desired to capture the image can include more than one facet.

It is further appreciated that according to some examples the light blocking member 48 disposed about the gemstone holding area 14 and can he integrally formed with the sleeve and is so disposed with respect to the gemstone holding area 14 such that light is precluded from reaching certain sides of the gemstone however allowing light to imping on other sides thereof which can be one or more sides thereof

In addition, it is appreciated that the light blocking member 48 can be such which blocks majority of the light directed to other facets of the gemstone 5 however allowing some light to reach these facets. Since majority of the light impinge on the facet from the direction of which is image is obtained, the minor amount of light reaching other facet does not interfere and thus does not affect the quality of the obtained image.

In order to further block outside light through the aperture 16 formed on the cover portion 12b of the housing 12, the cap member 18 can be configured to block light, i.e. can be made of solid material, or can be coated with a light absorbing material

The cap member 18 can further include a centralizing member 17 defining a bore 19 configured to hold at least a portion of the gemstone 5 therein. The centralizing member 17 is configured such that when the cap member 18 is disposed over the aperture 16, the bore 19 is disposed coaxially with the camera 30 the lens 32 and the gemstone holding member 28. This way, the gemstone 5 is disposed such that the facet which it is desired to capture is substantially coaxially disposed with the camera 30, and the light impinging on the gemstone is symmetrically distributed on the inner walls thereof.

It will be appreciated that the imaging apparatus 10 can be provided with a few cap members 18 each having a centralizing member 17 of different size configured to centralize a gemstone having a certain diameter. Alternatively, the cap member 18 can include a removable centralizing member 17, such that various centralizing members can be utilized in accordance with the size of the gemstone.

Reference is now made to FIG. 4, according to the illustrated example the sleeve member 36 is disposed about the gemstone holding area 14 such that the upper edge thereof abuts against the inner surface of gemstone holding member 28 while the light blocking member 48 is disposed between the inner surface of the cover portion 12h and the edge of the sleeve member 36. The illumination device 40 is mounted about the sleeve member 36, such that light therefrom can enter the optical aperture 15, only through the inner volume of the sleeve member 36. The sleeve member 36 blocks light which is not directed towards the optical aperture 15 in the desired angle, i.e. at an angle in a range of 15 to 55 degrees with respect to the direction from which the image is captured. This way the illumination impinging on the desired side of the gemstone is substantially homogenous and symmetrically enters the gemstone.

According to another example sleeve member 36 can be configured as a diffuser and thus to reflect diffused light. Accordingly, the illumination device 40 can be configured to impinge light on a wall of a sleeve member 36 and the sleeve member in return is configured to reflect diffused light towards the optical aperture of the gemstone holding area 14. The sleeve member can be disposed with respect to the illumination device 40 and the gemstone holding area 14 such that a wall portion thereof receives light form an illumination device 40 and reflects diffused light towards the optical aperture 15 of the gemstone holding area 14. It is appreciated that the sleeve member according to this example is so disposed with respect to the optical aperture 15 such that it blocks light which is not directed towards the optical aperture 15 in the desired angle, i.e. at an angle in a range of 15 to 55 degrees with respect to the direction from which the image is captured.

According to an example the sleeve member 36 earl be disposed about the gemstone holding area 14, such that the tipper edge thereof abuts against the inner surface of the gemstone holding member 28 The bottom edge of the sleeve member 36 does not abut against the plate 42, such that a gap 39 in defined between the plate 42 and the bottom edge. The illumination device 40 can be mounted about the sleeve member 36 and can be configured to emit light towards the gap 39 and the diffusing member 37 mounted on the plate 42, such that the light is reflected towards the inner surface of the sleeve member 36. The light is then diffused by the diffusing member 37 and reflected back from the inner surface sleeve member 36 towards the optical aperture 15 of the gemstone holding area 14 at an angle in a range of 15 to 55 degrees with respect to the direction from which the image is captured.

It is appreciated that due to the sleeve shape of the sleeve member 36, the light traveling therein can be configured to reflect number of times between sides of the inner wall of the sleeve member until reaching the optical aperture 15. This way the light reflected a few times form the sleeve member is evenly distributed before reaching the optical aperture 15. In addition, the sleeve member 36, can be configured to absorb light rays which are not directed at an angle at the range of 15 to 55 degrees with respect to the direction from which the image is captured. It is appreciated that the sleeve member 36 can have other shapes and forms such that light impinging thereon is directed or reflected towards the optical aperture 15 at the desired angle, and such that light from the illumination device 40 directed at other angles does not reach the optical aperture 15. It is further appreciated that the size of the sleeve member 36 can be determined in accordance with the gemstone 5, such that substantially all the illumination impinging on the desired side thereof symmetrically enters therein. Accordingly, the sleeve can he configured to have various forms and shapes or can be replaced manually or automatically in accordance with the gemstone's shape.

It is appreciated that the gemstone imaging apparatus 10 allows obtaining high quality photos of gemstones using standard mobile phones, and by utilizing a common LED illumination device. The apparatus 10 thus allows obtaining a high quality photo of a gem “on the go”, i.e. at exhibitions or meetings, without having to set up a special environment with appropriate illumination condition and macro lens. The apparatus 10 can thus be part of a platform for enhancing a variety of operations related to gemstone trading and retail—photography, purchase, inventory management, identification, quality estimation, visualization and sharing of gem information.

The image of the gemstone can be carried out with a mobile device having a camera and processing power to take a sequence of high quality images of a gemstone. The gemstone 5 is inserted into the gemstone holding area 14, and the mobile device is placed in the seat 25. The controller 22 or the mobile device can be provided with a software on the mobile device is used to control the image capturing process.

According to an example, the mobile device can be provided with a software configured to share the obtained image. Alternatively, a software can be installed on a second computing device, such as a second mobile phone, a laptop, etc., configured to communicate with the apparatus 10 or the mobile device disposed therein.

For example the software can be configured to upload the obtained image through the interne to a cloud database. The cloud database can be configured to allow user to add information to the uploaded image or the sequence of images by adding text to the image. The information can include the gemstone certificate ID which can be typed manually or uploaded by scanning the barcode on the certificate.

The shared information can be transferred as is, i.e. as images and accompanying text, or it can be sent to a virtualization toolkit that displays the gem in 3D in virtual reality such that viewers can interact with the gemstone image, as if it was in his hands.

In case of diamonds, the user gemstone database can be connected to the RapNet or similar databases providing information regarding the diamond's prices and availability. The databases can further be provided with a search engine which can be configured to analyze the gemstone information (images and text) and to provide recommendations to users. For example the database can provide information regarding similar stones, most popular stones, stones purchased in certain geographical area, etc.

The database can further be configured to allow financial transactions allowing users to directly purchase the gemstone.

The database can further include an augmented reality engine which can be configured to detect and identify defects on the gemstone by applying computer vision algorithms and comparing the image with the certificate of the gemstone. The augmented reality engine can further be configured to mark the defects on the image or the video of the gemstone.

Those skilled in the art to which the presently disclosed subject matter pertains will readily appreciate that numerous changes, variations, and modifications can be made without departing from the scope of the invention, mutatis mutandis.

1. An imaging apparatus for imaging a gemstone having a plurality of planes, apparatus comprising:
a gemstone holding area defining an optical aperture;
a camera configured for capturing an image of at least one plane of the gemstone and being so disposed with respect to said area so as to allow capturing said image through said optical aperture from at least a first direction of said a gemstone holding area;
an illumination device; and
a sleeve member disposed about said optical aperture and being configured for directing illumination from said sleeve member towards said optical aperture such that at least the majority of said illumination enters said optical aperture at an angle in a range of 15 to 55 degrees with respect to said first direction.

2. The imaging apparatus of claim 1 wherein said sleeve member is configured to block at least a portion of the illumination directed towards said optical aperture at an angle in outside said range.

3. The imaging apparatus of claim 1 wherein said gemstone holding area includes a gemstone holding member including a plate disposed therein and configured such that an image of the gemstone held on said plate can be obtained therethrough from a direction of a predetermined facet of said gemstone.

4. The imaging apparatus of claim 1 wherein said plate includes an aperture configured to allow capturing said image therethrough.

5. The imaging apparatus of claim 1 wherein said camera includes a plurality of cameras each being so disposed with respect to said optical aperture such that a plurality of images of the gemstone can be obtained each image being a captured from a predetermined direction.

6. The imaging apparatus of claim 1 wherein said camera includes a plurality of cameras each being configured to obtain an image of the gemstone in a predetermined light spectrum.

7. The imaging apparatus of claim 1 wherein said camera is configured to obtain an image of the gemstone having at least one plane in focus.

8. The imaging apparatus of claim 1 further comprising a focusing device configured to obtaining an in focus image of a predefined plane of the gemstone.

9. The imaging apparatus of claim 1 further comprising a diffusing member configured to evenly diffuse the illumination from said illumination device.

10. The imaging apparatus of claim 9 wherein said diffusing member is mounted on a plate inside the housing and being so disposed with respect to said sleeve member such that illumination from said illumination device is directed towards said diffusing member and such that diffused illumination from said diffusing member is reflected towards said sleeve.

11. The imaging apparatus of claim 9 wherein said diffusing member is configured for a negligible specular reflection of said illumination towards an inner surface of said sleeve member.

12. The imaging apparatus of claim 9 wherein said illumination device includes a plurality of illuminating elements each being disposed on one side of the gemstone holding area and being directed towards said diffusing member such that said diffusing member is illuminated from multiple direction.

13. The imaging apparatus of claim 1 wherein said sleeve member includes a symmetric shape, such illumination reflected therefrom is symmetrically directed towards said optical aperture.

14. The imaging apparatus of claim 1 wherein said sleeve member is slanted in a direction between said optical aperture and said camera.

15. The imaging apparatus of claim 1 wherein said sleeve member is coaxially disposed. with respect to said gemstone holding area such that the distance between said optical aperture and a surface of said sleeve member which reflects said illumination is even from all directions.

16. The imaging apparatus of claim 1 wherein said sleeve member is configured to reflect illumination towards said optical aperture such that said illumination impinges on inner facets of the gemstone forming thereby contrasts between the reflection of one inner facet and an adjacent inner facet.

17. The imaging apparatus of claim 1 further comprising a light blocking member disposed about said gemstone holding area and being configured for blocking illumination directed to other facets of the gemstone other than the facets thereof from which it is desired to obtain the image.

18. The imaging apparatus of claim 1 wherein said gemstone holding area includes an aperture for accessing said gemstone holding area from an outer surface of the apparatus, and a cap member configured to be disposed over said aperture and being configured to block light.

19. The imaging apparatus of claim 18 wherein said cap member further include a centralizing member configured to urge the gemstone in said gemstone holding area to be coaxially disposed with said camera.

20. A method for capturing an image of a gemstone having a plurality of planes, the method comprising:
placing a gemstone in gemstone holding area defining an optical aperture;
disposing a camera with respect to said gemstone holding area such that an image of said gemstone can be captured through said optical aperture from at least a first direction of said a gemstone holding area;
illuminating said optical aperture such that at least the majority of said illumination enters said optical aperture at an angle in a range of 15 to 55 degrees with respect to said first direction; and,
capturing an image of at least one plane of said gemstone.
